(19) United States
(12) Patent Application Publication
(10) Pub. No.: US 2025/0149197 A1
(43) Pub. Date: May 8, 2025

(54) Method for controlling a pressurized water reactor, computer program product and control system

(71) Applicant: FRAMATOME GmbH, ERLANGEN (DE)

(72) Inventor: Victor Morokhovskyi, ERLANGEN (DE)

(21) Appl. No.: 18/836,745

(22) PCT Filed: Feb. 9, 2022
(86) PCT No.: PCT/EP2022/053110

§ 371 Date: Aug. 7, 2024

(51) Int. Cl. G21D 3/08; G21C 7/22

(52) U.S. Cl. CPC G21D 3/08; G21C 7/22

(57) ABSTRACT

A method for controlling a pressurized water reactor, computer program product and control system, the pressurized water reactor includes a reactor core and a primary cooling circuit. The primary cooling circuit includes a primary cooling medium, which includes: acquiring a plurality of measurable reactor process variables and obtaining a plurality of non-measurable reactor process variables. The method further includes calculating future axial offsets at the end of a predetermined prediction time interval for a plurality of different possible boration/dilution actions based on the plurality of measurable reactor process variables and the plurality of non-measurable reactor process variables, the axial offset being a normalized difference between power of an upper half of the reactor core and a lower half of the reactor core. The calculation of the future axial offset for each of the plurality of different possible boration/dilution actions is performed in parallel.

The present disclosure concerns a method for controlling a pressurized water reactor, the pressurized water reactor comprising a reactor core and a primary cooling circuit comprising a primary cooling medium, the method comprising: acquiring a plurality of measurable reactor process variables; and obtaining a plurality of simulated real time non-measurable reactor process variables.

Further, the present disclosure concerns a computer program or FPGA configware product comprising commands for executing, a method for controlling a pressurized water reactor when loaded and executed on a processor or on a FPGA, the pressurized water reactor comprising a reactor core and a primary cooling circuit comprising a primary cooling medium.

In addition, the present disclosure relates to a control system for controlling a pressurized water reactor, the pressurized water reactor (PWR) comprising a reactor core and a primary cooling circuit comprising a primary cooling medium, the system comprising: acquiring a plurality of measurable reactor process variables; obtaining a plurality of simulated real time non-measurable reactor process variables.

### BACKGROUND

Pressurized water reactors have a plurality of control rod groups, which are used to control the power of the nuclear reactor. A part of these groups forms a so-called power control bank. In some reactor types, for example the French type and German type this bank is called P-bank or D-bank respectively. For example, a power control bank can include four or six groups of control rods used for controlling the power and moved within the reactor core according to a control program.

Further, PWR comprises a second plurality of control rod groups forming a so-called heavy bank, which comprises more control rod groups than the power control bank and generally used for shutdown purposes and normally pulled out of the reactor core. This bank is called H-bank in French type PWR or L-bank in German type PWR.

One of the biggest challenges of flexible operation (maneuvering) of pressurized water reactor (PWR) is prevention of possible xenon oscillations. Control concepts, which are currently used, keep the reactor power axial offset (AO) in appropriate band for this purpose.

The axial offset AO represents a normalized difference between the fission power of the upper and lower halves of the reactor core and characterizes the axial power distribution within the core.

A favorable value of AO, also called reference value AOref, avoids a buildup of adverse iodine and xenon distribution in the core and thus prevents xenon oscillations. French and German PWRs use for this purpose their heavy banks. Therefore, they are considered to have a movable heavy bank. Since the effect of heavy bank on AO is direct and instant, corresponding control devices are quite simple. In such cases, the heavy bank is movable as a whole in a small range (for example upper 20 cm of the core) to control the axial offset (AO).

Other types of pressurized nuclear reactors have not such heavy banks, which are movable for controlling the axial offset. Examples of such nuclear power plants are so-called Mode A plants and VVER (from Russian: [symbol] [symbol] [symbol] ; transliterates as vodo-vodyanoi energetichesky reaktor: water-water energetic reactor) nuclear power plants. Operators of such NPPs practice to use manual boration/dilution function to keep the AO. Such method is difficult, because injection of boric acid or demineralized water has only indirect and quite slow (around 5 min) effect on the AO. Thus, injection masses should be pre-calculated. However, a pre-calculation is difficult as the reactor physics is complex and the state of the reactor core is not constant.

Operators use in such a case a phenomenological method: First they make a test injection of boric acid or demineralized water in order to see the reaction. Then, scaling the result of a test injection, operators calculate the next injection step. Since the effect of injection is delayed, such procedure is difficult, inaccurate and not fast enough for power maneuvering.

WO2020224764 A1 discloses a stochastic based method for governing a pressurized water reactor. For that purpose, state variables are predicted on the basis of their measured current values and their history. Then possible trajectories for actuating variables for a future time interval are deterministically initiated. After that, the algorithm tries small random modification of these trajectories and calculates a figure of merit on the basis of a value table for current and modified trajectories keeping the trajectory giving better figure of merit. After that the program tries a next random modification.

CN111814343 discloses the calculation of the power distribution of a nuclear reactor. The calculation includes a solving of simultaneous equation set.

CN104036837 B relates to a method for analyzing the uncertainty of monitoring power of a nuclear reactor.

### SUMMARY

An object of the present disclosure is to provide a simple and accurate method to control a nuclear reactor avoiding xenon oscillations during maneuvers by reducing the axial offset, in particular a pressurized water reactor.

According to one aspect, a method for controlling a pressurized water reactor, the pressurized water reactor comprising a reactor core and a primary cooling circuit comprising a primary cooling medium, the method comprising:
acquiring a plurality of measurable reactor process variables;
obtaining a plurality of non-measurable reactor process variables; wherein the method further comprises:
calculating future axial offsets at the end of a predetermined prediction time interval for a plurality of different possible boration/dilution actions based on the plurality of measurable reactor process variables and the plurality of non-measurable reactor process variables, the axial offset being a normalized difference between power of an upper half of the reactor core and a lower half of the reactor core, wherein the calculation of the future axial offset for each of the plurality of different possible boration/dilution actions is performed in parallel;
determining a boration/dilution action to be performed based on the calculated future axial offsets, AO, for the plurality of different possible boration/dilution actions and corresponding reference axial offsets, AOref; and
commanding the determined boration/dilution action in the primary cooling circuit.

Further embodiments may relate to one or more of the following features, which may be combined in any technically feasible combination:
the method further comprising: receiving the planned electric power change for a predetermined time, wherein the calculation of the future axial offsets, AO, for a plurality of different possible boration/dilution actions at the end of the predetermined prediction time interval is further based on the planned electric power change during predetermined prediction time interval;
the method further comprising, determining the current axial offset and, if the difference between the current axial offset and a current reference axial offset exceeds a predefined threshold, performing the step of calculating future axial offsets, AO, at the end of the predetermined prediction time interval for a plurality of different possible boration/dilution actions, and, in particular, the corresponding reference axial offsets;
the measurable reactor process variables include a coolant inlet temperature, a coolant outlet temperature, an average coolant temperature, a live steam pressure, current axial offset, a thermal power of the reactor core, power control rod positions, in-core neutron fluxes, ex-core neutron fluxes and/or boron concentration;
the non-measurable reactor process variables include nuclide concentrations, for example ¹³⁵Xe concentration and/or the ¹³⁵I concentration, reaction rates, heating powers, fuel temperatures and/or coolant temperatures and/or in particular spatial distributions of these values;
the non-measurable reactor variables are obtained by a reactor co-simulator.
the boration/dilution action to be performed is determined based on an interpolation, in particular a linear interpolation, between at least two points created by pairs of boration/dilution value and the calculated future axial offset, wherein in particular a boration/dilution value for a boration/dilution action to be performed is selected from the interpolation such that the difference between the axial offsets and the corresponding reference axial offset is zero, in particular when the corresponding reference axial offsets are equal;
the boration/dilution action to be performed is determined based on an interpolation, in particular a linear interpolation, between at least two points created by pairs of boration/dilution value and the difference between the calculated future axial offset and the corresponding reference axial offset, wherein in particular a boration/dilution value for a boration/dilution action to be performed is selected where an interpolation curve of the interpolation presents a zero-crossing in the dimension representing the difference between the axial offsets and the corresponding reference axial offsets;
the boration/dilution action to be performed is determined based on an interpolation between two neighboring points giving the smallest negative difference between the future axial offset and the corresponding reference axial offset and the smallest positive difference between a future axial offset and the corresponding reference axial offset;
the boration/dilution action to be performed is determined by selecting a boration/dilution action from the plurality of different possible boration/dilution actions, which leads to the smallest absolute difference between the respective future axial offset and the corresponding reference axial offset;
each calculation of a future axial offset at the end of predetermined time span for a plurality of different possible boration/dilution actions is based on the same reactor process variables except the boration/dilution action;
the predetermined prediction time interval is between 5 and 15 minutes;
the calculation of the future axial offsets at the end of a predetermined prediction time interval for a plurality of different possible boration/dilution actions is based on numerical solving of integral equations, in particular based on reactivity balance equations;
the corresponding reference axial offset is respectively a reference axial offset at the end of the prediction time interval calculated for each possible boration/dilution action, in particular based on the reactor power and/or positions of the power control rods at the end of the prediction time interval;
the corresponding reference axial offsets are equal for each possible boration/dilution action, wherein in particular the corresponding reference axial offset is based on a measurement, for example based on a discontinuous measurement.

The method according one of the preceding claims is, in an embodiment, a computer-implemented method.

According to another aspect, a computer program or FPGA (Field Programmable Gate Array) configware product is provided comprising commands for executing a method for controlling a pressurized water reactor according to an embodiment disclosed herein when loaded and executed on a processor or FPGA, the pressurized water reactor comprising a reactor core and a primary cooling circuit comprising a primary cooling medium.

A computer-readable data carrier, for example a hard disc, a solid state disc, a CD-ROM, a DVD, having stored thereon the computer program product according to an embodiment disclosed herein.

According to another aspect, a data carrier signal carrying the computer program or FPGA configware product according to an embodiment disclosed herein is provided.

Embodiments are also directed to the control system for carrying out the disclosed methods steps and in particular including apparatus parts and/or devices for performing described method steps.

According to another aspect, a control system is provided for controlling a pressurized water nuclear reactor, the pressurized water nuclear reactor comprising a reactor core and a primary cooling circuit comprising a primary cooling medium, the system comprising: an acquisition module adapted to acquire a plurality of measurable reactor process variables; a reactor co-simulator adapted to obtain a plurality of non-measurable reactor process variables; wherein the control system is further comprises:
a multi-channel predictor adapted to receive the non-measurable reactor process variables and the measurable process variables, wherein the multichannel predictor is further adapted to calculate future axial offsets at the end of a predetermined prediction time interval for a plurality of different possible boration/dilution actions based on the plurality of measurable reactor process variables and the plurality of non-measurable reactor process variables, the axial offset being a normalized difference between power of an upper half of the reactor core and a lower half of the reactor core, wherein the calculation of the future axial offset for each of the plurality of different possible boration/dilution actions is performed in parallel;
an assessment device adapted to determine a boration/dilution action to be performed based the calculated future axial offsets for the plurality of different possible boration/dilution actions and corresponding reference axial offsets, AOref;
wherein the control system is further adapted to command the determined boration/dilution action in the primary cooling circuit.

The method steps may be performed by way of hardware components, firmware, configware, software, a computer programmed by appropriate software, by any combination thereof or in any other manner.

Further advantages, features, aspects and details are evident from the dependent claims, the description and the drawings.

### BRIEF SUMMARY OF THE DRAWINGS

The accompanying drawings relate to embodiments of the present disclosure and are described in the following:

FIG. 1 shows schematically a nuclear power plant;

FIG. 2 shows schematically a principle of a method;

FIG. 3 shows schematically the time line; and

FIG. 4 shows schematically a flow chart of a method according to an embodiment.

### DETAILED DESCRIPTION

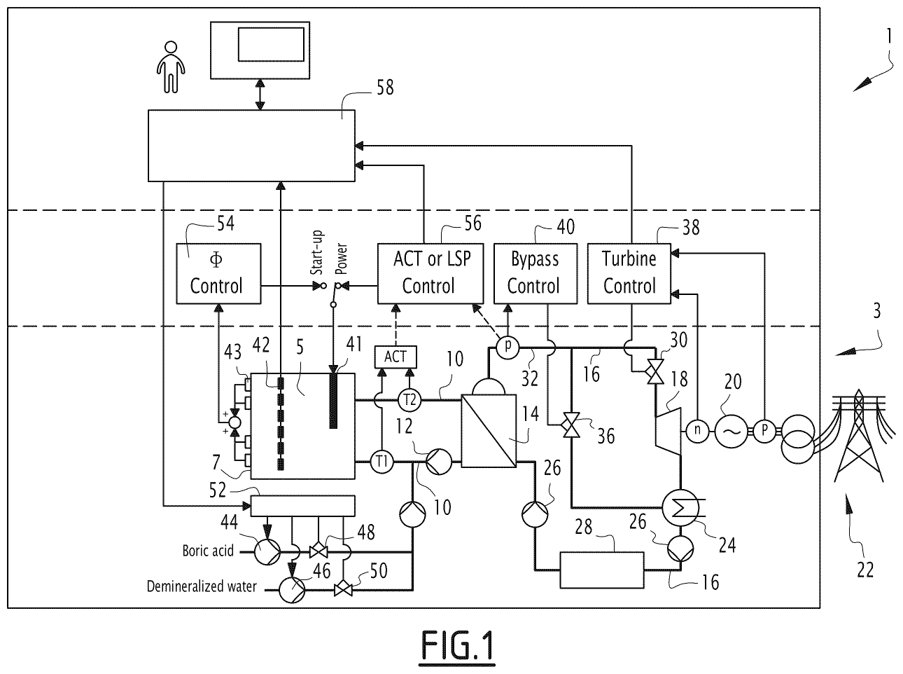

FIG. 1 provides a simplified schematic overview of a nuclear power plant 1 with a pressurized water reactor (PWR) 3. The PWR 3 comprises a reactor core 5 having a reactor pressure vessel (RPV) 7. During operation, the heat produced by the reactor core 5 within the reactor pressure vessel 7 is transferred by a primary cooling medium, for example water, circulating in a primary cooling circuit 10 under the driving force of a reactor coolant pump (RCP) 12. The primary cooling circuit includes one or more steam generators 14, in which the heat of the primary cooling medium is transferred to a secondary cooling medium circulating in a secondary cooling circuit 16, thereby evaporating the secondary cooling medium. The primary cooling medium is then conducted again into the reactor core 5 by the RCP 12.

According to embodiments, the nuclear power plant 1 is a Mode A plant or a VVER.

The steam produced by the one or more steam generators 14 drives a steam turbine 18, which is coupled to an electric generator 20 to generate electricity. The generated electricity is fed into an electrical grid 22. After passing through the steam turbine 18 the steam is condensed in at least one condenser 24 and then provided again into the at least one steam generator 14 by at least one feedwater pump 26. A feedwater tank 28 within the secondary cooling circuit 16 can be used, in some embodiments, as a compensating reservoir.

In some embodiments, the flow rate of steam passing into the steam turbine 18 may be controlled by one or more turbine valves 30 in a steam feed line 32 between the at least one steam generator 14 and the steam turbine 18 in the secondary cooling circuit 16. In some special situations, for example plant start-up, turbine trip, etc., there is excess steam, which is directly guided from the at least one steam generator 14 to the at least one condenser 24 via a bypass line 34 comprising one or more bypass valves 36. The one or more turbine valves 30 and the one or more bypass valves 36 are controlled by a turbine controller 38 and a bypass controller 40 respectively. The turbine controller 38 and a bypass controller 40 use as inputs in particular the steam pressure p in the steam feed line 32, the rotational speed n of the steam turbine 18, and/or the electric power P output of the electric generator 20.

The power of the reactor core 3 is controlled in particular via a number of control rods, which can be inserted into the reactor core 5. The control rods absorb neutrons and depending on the insertion depth, the power production of the nuclear reactor can be controlled, for example because they influence the neutron flux within the reactor. According to embodiments, the control rods are so called black rods. Usually, the control rods in pressurized water reactors 3 are grouped into control assemblies. The rods of a single control assembly are driven by a single rod drive mechanism and move together within a single fuel assembly. In particular, a plurality, for example four to six symmetrically located control assemblies form a control group. The control groups are further grouped to control banks. PWRs possess usually two control banks: power control bank, also called P-bank and a heavy bank called H-bank. The power control bank is used to control the reactor power (P=power) and the heavy bank is used for shut down (H=heavy). In the following, the control rods of the P-bank or power control bank will be also called power control rods 41.

According to embodiments, the number of control groups of the heavy bank is higher than the number of control groups of the power control bank, in particular the number of control rods of the heavy bank is higher than the number of power control rods of the power control bank. For example, about 75 percent of the control rods take part in the heavy bank.

In some embodiments, some control rod groups can be selectively associated to the heavy bank or to the power control bank. According to an embodiment disclosed herein, the heavy bank is used only for shutdown of the PWR. It will be withdrawn just before the startup of the pressurized water reactor 3. During the power operation, the control rods of the heavy bank are located outside the reactor core 5. In other words, the H-banks are not movable.

For monitoring the pressurized water reactor 3, there are provided a plurality of detectors 42 within the reactor core 5 for continuous measurement of the neutron flux density and its spatial distribution. They are also called in-core detectors 42. According to an embodiment, eight times six detectors are provided in a so-called SPND (self-powered neutron detector) lances. Each lance includes six detectors, which are distributed along their longitudinal length along the height of the reactor core 5. The lances are provided in different fuel assemblies.

Further, there are ex-core neutron flux detectors 43 provided outside the reactor pressure vessel 7.

Long term modification of the reactivity, in particular due to xenon poisoning and fuel depletion is controlled by amending the boron concentration by injection of boric acid (boration) and/or demineralized water (dilution) into the primary cooling circuit 10. The addition of one of these fluids to the primary cooling circuit is called in the following boration/dilution action. Boron within the primary cooling circuit 10 acts as a neutron absorber. Thus with a higher concentration of boric acid the reactivity of the reactor core 5 and consequently its power decreases. To increase the reactivity, demineralized water is added to the primary cooling circuit 10 in order to reduce the concentration of boric acid and thus to increase the reactivity. According to an embodiment, the pressurized water reactor 3 comprises at least one first pump 44 (boration pump) to inject boric acid and at least one second pump 46 (dilution pump) to inject demineralized water into the primary cooling circuit 10 and thus also into the reactor pressure vessel 7. The amount of demineralized water and/or boric acid can be controlled using a boration valve 48, a dilution valve 50 and/or the pumps 44, 46. According to embodiments, the pumps 44, 46 are operated only in the case of a required injection of boric acid or demineralized water.

According to embodiments, which may be combined with other embodiments disclosed herein, an injection controller 52 is provided, which controls the operation of the pumps 44, 46 and/or the valves 48, 50.

Further, the nuclear power plant 1 comprises a controller 54 for the start-up of the pressurized water reactor 3. Such a controller is called ϕ-controller or neutron flux controller, which takes into account the neutron flux ϕ, typically measured by one or more ex-core detectors 43. In particular, in dependence on the measured neutron flux, the power control rods 41 are moved in or out of the reactor core 5.

The thermal power of the reactor core 5 can be obtained from the difference between the measured temperature T2 of the primary coolant medium at the outlet of the reactor pressure vessel 7 and the measured temperature T1 of the primary coolant medium at the inlet of the reactor pressure vessel 7. Fission power can be obtained from the neutron flux, in particular measured by the detectors 42 and/or 43.

The average reactor coolant temperature ACT represents an average of primary coolant medium inlet and outlet temperatures T1, T2. Alternatively, live steam pressure p in the secondary cooling circuit 16 can be taken instead of the primary coolant medium temperatures or the ACT as a variable to be controlled as explained here-below.

According to embodiments, there is provided reactor power controller 56, for example in form of an average coolant temperature (ACT) controller or live steam pressure (LSP) controller, responsible for power operation, in particular after start-up. The reactor power controller 56 relies on measured values for the temperatures of the primary cooling medium, in particular an average coolant temperature (ACT) derived from the primary coolant medium inlet temperature T1 and the primary coolant medium outlet temperature T2 with respect to the reactor core 5. In another embodiment, additionally or alternatively the steam pressure p in steam feed line 32 may be used. In particular, in dependence on the measured average coolant temperature ACT and/or live steam pressure p, the power control rods 41 are moved automatically into or out of the reactor core 5. They may be also moved to any intermediate positions.

According to embodiments, the power of the nuclear power plant 1 measured at the generator 20 is controlled by the turbine controller 38 via the turbine valves 30. The power control rods 41 are then moved by the reactor power controller 56 in order to adapt the power of the pressurized water reactor 3 to the power required by the generator 20. ACT and/or LSP are used thereby as an indicator of power imbalance.

The control of a pressurized water reactor 3 is rendered complicated in particular due to the complex dynamics of the ¹³⁵Xe (called xenon or Xe here-below) concentration in the reactor core. Xenon acts as a strong neutron poison or neutron absorber. The xenon values change within hours. The xenon concentration in the reactor core 5 is dependent on previous xenon and iodine concentrations and on the power of the pressurized water reactor 3. The xenon is created mostly due to the decay of iodine, which is one of the fission products and disappears when absorbing neutrons and by decay. However, the creation of Xe and its decay appear with a time delay, so that for the actual and future state of the pressurized water reactor 3, the actual, past and possible future values of iodine and xenon must be taken into account, in particular for optimal controlling of the position of the power control rods 41 via the concentration of the boric acid (by boration/dilution actions).

When a nuclear power plant 1 operates a long time at a constant power, the xenon concentration reaches an equilibrium or steady state. The xenon reactivity is a linear function of the xenon concentration.

The axial offset AO represents a normalized difference between the fission power of the upper and lower halves of the reactor core 5. The axial offset AO represents a normalized difference between the fission power of the upper and lower halves of the reactor core and characterizes the axial power distribution within the core.

$$AO = \frac{{P}_{u} - {P}_{l}}{{P}_{u} + {P}_{l}}$$

Pᵤ represents the fission power in the upper halve of the reactor core and Pₗ represents the fission power in the lower halve of the reactor core.

The in-core detectors 42 and/or the ex-core detectors 43 may be used for determining the axial offset AO.

Further, there is provided a boration/dilution controller 58 for determining the needed boration or dilution, in particular depending on the current and predicted axial offset AO and/or the expected power to be provided by the nuclear power plant 1.

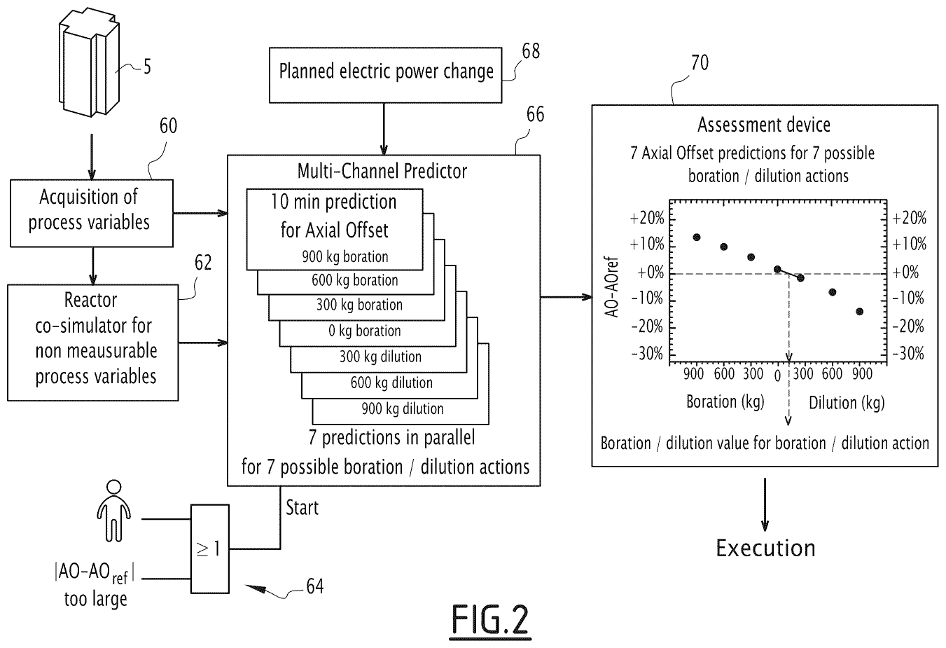

FIG. 2 shows schematically a principle of a method according to an embodiment, which is in particular performed by the boration/dilution controller 58.

Measurable reactor process variables are acquired by an acquisition module 60. Measurable reactor process variables are for example coolant inlet temperature (T1), coolant outlet temperature (T2), average coolant temperature (ACT), the live steam pressure p, the current axial offset (AO), the thermal power of the reactor core, power control rod positions, in-core neutron fluxes, ex-core neutron fluxes and/or boron concentration in the primary coolant medium. As it can be seen from the above, the measurable reactor process variables also include reactor process variables obtained from a combination of a plurality of different measurements.

Non-measurable reactor process variables are determined, for example nuclide concentrations, in particular the concentration and/or spatial distribution of ¹³⁵I, ¹³⁵Xe and/or other nuclides, in particular by a reactor co-simulator 62. Other possible non-measurable parameters or variables include reaction rates, heating powers, fuel temperatures and/or coolant temperatures, the non-measurable reactor process variables may also include a spatial distribution of these values. The non-measurable parameters are needed for the calculation of reactivity components within a multi-channel predictor 66. Furthermore, the co-simulator is adapted to schedule the averaged cross sections depending on the fraction of the ²³⁹Pu in the fuel.

The reactor co-simulator 62 is a real time simulator running synchronous with the reactor. The real time synchronization is achieved by use of the process variables acquired by the acquisition module 60. In particular, non-measurable variables are based on measurable reactor process variables and the evolution of the measurable and non-measurable reactor process variables in the past.

In case the current axial offset (AO) exceeds a predefined band around the current reference axial offset AOref, or initiated by an operator, see block 64, the multi-channel predictor 66 is triggered. In other words, the multi-channel predictor 66 is started in a discontinuous manner, in particular manually or automatically. The current reference axial offset AOref corresponds to a steady state and is a known parameter in pressurized water reactors 3 and may be measured or calculated.

In some embodiments, AOref is a constant parameter resulting from a discontinuous measurement performed during steady phases of reactor operation. In some other embodiments, AOref is a calculated value, which depends on the reactor power and rod positions. The multichannel predictor 66, the determination whether the axial offset exceeds a predefined band around the reference axial offset and/or the triggering may be integrated in boration/dilution controller 58.

The multi-channel predictor 66 is adapted to calculate several predictions of an axial offset (i.e. future axial offsets) in parallel, each single prediction calculation is performed based on individual boration or dilution action corresponding to different injections of boric acid or demineralized water into the primary cooling circuit 10. The multi-channel predictor 66 runs a plurality of identical predictors. For example, between 5 and 15 different possible boration/dilution actions may be used for that purpose and run in parallel. The possible boration/dilution actions may vary between injection of 2000 kg demineralized water to injection of 2000 kg of boric acid, in particular between injection of 1000 kg demineralized water and injection of 1000 kg boric acid. One of the different possible boration/dilution actions may include also no injection of boric acid or demineralized water. The multi-channel predictor 66 performs the prediction for each of the different possible boration/dilution actions in parallel. In other words, they are performed at the same time.

In the example shown in FIG. 2 there are seven parallel channels calculating in parallel seven different predictions for seven different possible boration/dilution actions: 900 kg boration, 600 kg boration, 300 kg boration, no boration/dilution, 300 kg dilution, 600 kg dilution, 900 kg dilution respectively. Seven parallel simulations will result in seven different future axial offsets at the end of predetermined prediction time interval.

The multi-channel predictor 66 is adapted to predict or calculate the future axial offset AO for each possible boration/dilution action at the end of a predetermined prediction time interval. To make these predictions, the multi-channel predictor 66 is adapted to simulate all needed reactor process variables, for example, concentration and spatial distribution for xenon and iodine, within the predetermined prediction time interval. For example, the multi-channel predictor 66 is 10 times faster than real time. Each single predictor channel in the multi-channel predictor 66 starts with the same initial data, given by the acquisition module 60 and the reactor co-simulator 62, except the boration/dilution value of the respective boration/dilution action, and uses a planned electric power change 68, for example a planned electric power ramp, for example received from the turbine controller 38, during the predetermined prediction time interval and to calculate the future axial offset AO at the end of the predetermined prediction time interval, in particular based on the reactor process variables during the predetermined prediction time interval. In particular based on the planned electric power change 68 a corresponding power change of the nuclear reactor is calculated for determining the future axial offset AO. In other words, the start values for the multi-channel predictor 66 are given by the real time acquisition of one or more measurable process variables of the pressurized water reactor 3 and one or more co-simulated non-measurable process variables, for example nuclide concentrations.

For example, the planned electric power change may be a power program for the next 10 minutes. In most embodiments, the planned electric power change is a power ramp, but it can be more complex, for example, a combination of two power ramps, for example 5 min constant power and then 5 min ramp.

According to embodiments, for the prediction, the reactor core is divided into a plurality of nodes, in particular 2 to 20 nodes, for example 8 to 16 nodes, for example 12 nodes. In an embodiment, one half of the nodes represent the upper half of the reactor core 5 and the other half of the nodes lower half of the reactor core 5. Reactivity balance equations, in particular for each node, are solved for power reactivity, according to embodiments for a set of time points, for example between 150 and 250 points, in particular 200 points, in steps within the prediction time interval. The local thermal power for each node can be then deduced from the power reactivity found. Calculation in steps reduces an integral equation in each node to a series of algebraic equations. There is one algebraic equation in each time step for each node. These equations take into account in particular neutron transport between the nodes and neutron leakage through the top and the bottom surfaces of the reactor core 5. All nuclide concentrations and corresponding reactivity components necessary for the balance equation are calculated in this embodiment according to forward Euler method. Among others, the multi-channel predictor 66, in particular predictors of the multi-channel predictor 66, are adapted to calculate the position of the control rods 41 simulating the function of the reactor power controller 56. According to embodiments, the integral equations are numerically solved by reduction of integral equations to a series of algebraic equations. In other words, the calculations performed by the multi-channel predictor 66 are deterministic and solve a series of algebraic equations for each node.

Generally, the calculation method takes into account non-uniform time dependent iodine and xenon distributions. The xenon concentration is an integral over time of an expression containing xenon concentration itself as well as neutron flux and iodine concentration. The iodine concentration is an integral over time of an expression containing iodine concentration itself and fission rate. Thus, at least two integrals over time per node are obtained. Due to neutron transport, reactivity balance equations, containing these integrals are coupled, composing a system of integral equations. The boron concentration in the primary cooling medium is a term in all of these reactivity balance equations, and the axial offset is a scalar, resulting from the integral values.

Embodiments, which use a discontinuous measurement to determine reference axial offset AOref, will have common corresponding reference axial offset AOref value for all possible boration/dilution actions. In other words, then the corresponding reference axial offsets are equal for each possible boration/dilution action.

In some embodiments, which use calculated reference axial offset AOref, each possible boration/dilution action will have an individual corresponding reference axial offset AOref at the end of the prediction time interval, since in this case the corresponding reference axial offset AOref depends in particular on rod positions. In this case, the multi-channel predictor 66 is adapted to calculate also corresponding reference axial offset AOref for each possible boration/dilution action according to reactor power and positions of the power control rods 41 at the end of the prediction time interval.

According to embodiments, the difference between the future axial offset AO and the corresponding reference axial offset AOref at the end of the prediction time interval for each of the possible boration/dilution actions is provided from the multi-channel predictor 66 to the assessment device 70. In embodiments where the corresponding reference axial offsets are equal, the multi-channel predictor 66 may send only the future axial offsets to the assessment device.

Then, after obtaining the results of the plurality of single predictions of the future axial offset AO and, in particular, the individual reference axial offset AOref for each boration/dilution action, a boration/dilution value for a boration/dilution action to be performed is chosen promising the best reduction of the difference between the axial offset and the corresponding reference axial offset (AO-AOref).

For example, an assessment module or device 70 is adapted to receive a set of possible boration/dilution values and the corresponding values of the difference between the future axial offset AO and the corresponding reference axial offset AOref (AO-AOref). In embodiments, where the corresponding reference axial offsets are equal, the assessment module 70 may only receive the future axial offsets.

The assessment module 70 is adapted to determining a boration/dilution action to be performed based on the calculated future axial offsets AO and in particular based on the calculated values for corresponding reference axial offset AOref for the plurality of different possible boration/dilution actions, for example by comparison of the resulting values for the future axial offset AO with the corresponding reference axial offset AOref.

In an embodiment, boration/dilution action to be performed is selected from the plurality of different possible boration/dilution actions, leading the smallest absolute difference between the respective future axial offset and the corresponding reference axial offset |AO−AOref|.

In some embodiments, the assessment module 70 is adapted to interpolate or to create an interpolation curve between two neighboring points giving the smallest negative difference between the future axial offset and the corresponding reference axial offset (AO-AOref) and the smallest positive difference between the future axial offset and the corresponding reference axial offset (AO-AOref), in particular in order to determine or calculate a boration/dilution action to be performed. In other words, the interpolation is determined between the neighboring smallest positive and the smallest negative values of AO-AOref, where AO is the future axial offset and AOref is the corresponding reference axial offset.

The points are created by pairs of boration/dilution value and the corresponding difference between the future axial offset and the corresponding reference axial offset, both calculated by the multi-channel predictor 66.

Alternatively, in embodiments, where the corresponding reference axial offsets are equal, the assessment module 70 is adapted to create the points by pairs of boration/dilution value and the corresponding future axial offsets. Like in FIG. 2, in this case, where the corresponding reference axial offsets are equal, the points may be also created by the assessment module 70 by pairs of boration/dilution value and the corresponding difference between the future axial offset and the corresponding reference axial offset.

According to embodiments, the assessment device 70 is adapted to create an interpolation curve or perform linear interpolation of the axial offset with respect to a boration/dilution value based on the difference between the future axial offset and the corresponding reference axial offset for each possible boration/dilution action at the end of the predetermined prediction time interval received from the multi-channel predictor.

In some embodiments, a linear interpolation may be performed by the assessment device 70.

For example, in case of an interpolation, a boration/dilution value for an boration/dilution action to be performed is selected, that corresponds to or that enables to reach a desired axial offset AO, where AO−AOref=0. In other words, a boration/dilution value for a boration/dilution action to be performed is selected from the interpolation such that the difference between the axial offset and the corresponding reference axial offset is zero, in particular when the corresponding reference axial offsets are equal.

As it is shown in the example of FIG. 2, when the points are created by pairs of boration/dilution value and the corresponding difference between the future axial offset and the corresponding reference axial offset, a boration/dilution value for a boration/dilution action to be performed is selected from the interpolation, where the value in the ordinate is zero. In other words, particular a boration/dilution value for a boration/dilution action to be performed is selected, where an interpolation curve of the interpolation presents a zero-crossing in the dimension representing the difference between the axial offset and the corresponding reference axial offset.

According to embodiments, the axial offset AO at the end of the prediction time interval is set to a desired axial offset and the corresponding boration/dilution action is determined from the interpolation curve or linear interpolation. For example, the result is one equation AO-AOref=0 with one variable (boration/dilution value for a boration/dilution action to be performed). According to embodiments, this final equation with AO-AOref at the end of the predetermined prediction time interval received from the multi-channel predictor will be solved for boration/dilution value by the assessment device 70 as shown in FIG. 2.

In an example, the prediction time interval is between 5 and 15 minutes, in particular about 10 minutes.

The movement of power control rods 41 in a nuclear power plant is usually limited to some allowed movement range. According to embodiments, the multi-channel predictor 66 takes into account the rod position limitation and provides no results to the assessment device corresponding to boration/dilution actions, which would lead to a movement of the power control rods 41 outside their allowed movement range.

The boron concentration can be adjusted by actuating the boration/dilution pumps 44, 46 and valves 48, 50 via the injection controller 52. This can be done manually or automatically using the result obtained by the assessment module 70.

The reactor needs less than 7 minutes to react on the boration/dilution action. The axial offset shall then be close to the AOref. After that, the boration/dilution controller 58 is available for the next possible action, which can be triggered by the block 64.

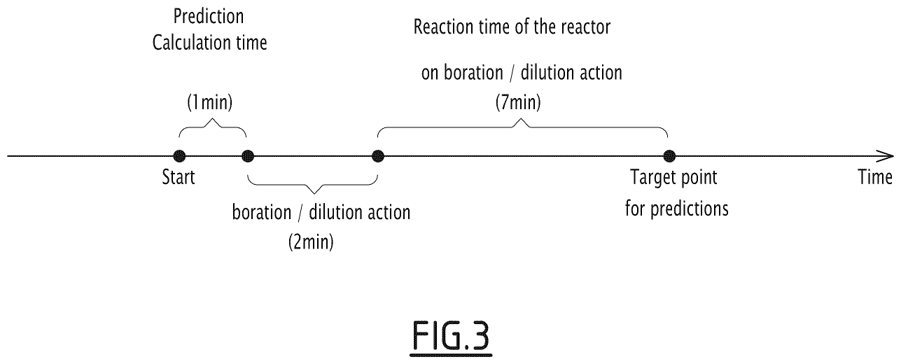

FIG. 3 shows schematically a time line. At the start, the multi-channel predictor 66 receives the measurable and non-measurable reactor variables and starts the axial offset AO predictions to obtain the future axial offsets and in particular the reference axial offsets. The predictors represent reactor simulators running faster than real time (e.g. 10 times faster). Then the calculation results for future axial offsets AO at the end of the predefined prediction time interval are assessed for example by the assessment module 70, in particular to determine a boration/dilution action to be performed. The time for the prediction and subsequent assessment is about 1 minute. Then, the boration/dilution action is commanded and in particular executed, which takes in this example about two minutes. The remaining time of 7 minutes is required by the nuclear reactor to react on the boration/dilution action so that at the target time point (corresponding to the end of the predetermined prediction time interval) the desired value of AO should be achieved.

The effect of a boration/dilution action on the reactor power density is almost uniformly distributed over the core volume. Thus, the boration/dilution action cannot directly influence the power distribution and therefore the axial offset AO. The effect is indirect: injection action changes the integral reactor power, and the reactor power controller 56, for example implemented as average coolant temperature (ACT) controller or as live steam pressure (LSP) controller, compensates this change, by moving the power control rods 41. Mode A plants are equipped with ACT controller, whereas VVER plants are equipped with LSP controllers. In some nuclear power plants, for example VVER, in particular a method combining both options can also be used. In this case, the power controller 56 takes into account both, ACT and LSP. The power control rods 41 effect the power distribution in the core, thus changing the axial offset AO.

In this way, the axial offset AO can be controlled without specific heavy bank (H-bank), only by the power control rods 41 of the P-bank. In other words, according to the present disclosure, the axial offset can be held in a desired band using boration/dilution action, whereas the needed masses will be automatically fast and precisely pre-calculated.

One or more different elements of FIG. 2 may be part of the boration/dilution controller 58 and/or may be arranged on one or more devices and grouped in an arbitrary way. Further, the modules disclosed of FIG. 2 can be combined with other controllers of the nuclear power plant 1, for example, the reactor power controller 56 and/or the injection controller 52.

The present disclosure increases the reactor safety through easing of the operator team working load and avoiding erroneous injections of boric acid or demineralized water. Simultaneously the present disclosure helps to save boric acid and demineralized water through precise pre-calculation of needed masses. Moreover, saving boric acid and demineralized water, the present disclosure helps to save effluents from the primary cooling circuit 10.

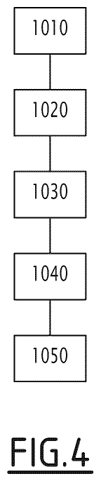

With respect to FIG. 4, a flow chart of a method according to an embodiment will be explained. In a first step 1010 a plurality of measurable reactor process variables is acquired. For example, this may be done by an acquisition module 60. As stated above, the measureable reactor process variables include variables that may be obtained by a plurality of continuously measured values, like for example coolant inlet temperature T1, coolant outlet temperature T2, the ACT, the live steam pressure p in the steam feed line 32, the axial offset AO, the thermal power of the reactor core, power control rod positions, in-core neutron fluxes, ex-core neutron fluxes and/or boron concentration.

In a further step 1020, a plurality of non-measurable reactor process variables is obtained. For example, the non-measurable reactor process variables are simulated in real time values. For example, a reactor co-simulator may simulate in parallel to the operation of the nuclear reactor non-measurable reactor process variables. Such non-measurable process variables depend not only on actual measured reactor process variables, but also on past values of measurable and non-measurable reactor process variables. As explained above, such non-measurable reactor process variables include nuclide concentrations, for example xenon concentration and/or the iodine concentration, reaction rates, heating powers, fuel temperatures and/or coolant temperatures and/or in particular spatial distributions of these values. These non-measurable process variables are used to calculate reactivity components within the predictors 66.

In a further step 1030 future axial offsets (AO) at the end of a predetermined prediction time interval for a plurality of different possible boration/dilution actions based on the plurality of measurable reactor process variables and the plurality of non-measurable reactor process variables are calculated. The axial offset being a normalized difference between power of an upper half of the reactor core 5 and a lower half of the reactor core 5, wherein the calculation of the axial offset for each of the plurality of different possible boration/dilution actions is performed in parallel, as explained above. This is for example performed by the multi-channel predictor 66. Each calculation of an axial offset at the end of predetermined time span for a plurality of different possible boration/dilution actions is based on the same reactor process variables, for example, the measurable and the non-measurable reactor process variables, except the boration/dilution value. The calculation of the future axial offsets (AO) at the end of a predetermined prediction time interval for a plurality of different possible boration/dilution actions is based on numerical solving integral equations and is therefore deterministic. In the embodiments, in particular which use calculated values of corresponding reference axial offset AOref, individual values of the corresponding reference axial offset AOref for different possible boration/dilution actions are calculated within the step 1030, in particular based on the reactor power and power control rod 41 positions at the end of the predetermined prediction time interval.

In a further step 1040, a boration/dilution action to be performed is determined based on the calculated future axial offsets (AO) for the plurality of different possible boration/dilution actions, whereas the difference between the future axial offset (AO) and the corresponding reference axial offset (AO-AOref) is evaluated. This may be performed for example by an assessment module 70. The assessment module 70 may determine the boration/dilution action to be performed by selecting one boration/dilution action of the plurality of different possible boration/dilution actions used in step 1030, in particular the boration/dilution action, which leads to the smallest absolute difference between the corresponding future axial offset and the corresponding reference axial offset. Alternatively, a boration/dilution action to be performed is determined by the assessment module based on an interpolation between at least two points created by pairs of boration/dilution value and the calculated difference of future axial offsets (AO) and the corresponding reference axial offset (AO-AOref), wherein in particular a boration/dilution action is selected that corresponds to boration/dilution value where the difference AO−AOref=0, as shown in FIG. 2. In other words, in particular a boration/dilution value for a boration/dilution action to be performed is selected from the interpolation such that the difference between the axial offset and the reference axial offset is zero.

In step 1050 the determined boration/dilution action in the primary cooling circuit 10 is performed or commanded. The injection may be performed automatically or manually.

### LIST OF REFERENCE SIGNS

1 nuclear power plant
3 pressurized water reactor
5 reactor core
7 reactor pressure vessel
10 primary cooling circuit
12 reactor coolant pump
14 steam generator
16 secondary cooling circuit
18 steam turbine
20 electric generator
22 electrical grid
24 condenser
26 feedwater pump
28 feedwater tank
30 turbine valves
32 steam feed line
34 bypass line
36 bypass valves
38 turbine controller
40 bypass controller
41 power control rods
42 in-core detectors
43 ex-core detectors
44 boration pump
46 dilution pump
48 boration valve
50 dilution valve
52 injection controller
54 neutron flux controller
56 reactor power controller
58 boration/dilution controller
60 acquisition module
62 reactor co-simulator
64 block triggering the multi-channel predictor
66 multi-channel predictor
68 planned electric power change (ramp)
70 assessment module

What is claimed is:

1-19. (canceled)

20: A computer-implemented method for controlling a pressurized water reactor, the pressurized water reactor comprising a reactor core and a primary cooling circuit comprising a primary cooling medium, the method comprising:
acquiring a plurality of measurable reactor process variables;
obtaining a plurality of non-measurable reactor process variables;
calculating future axial offsets, AO, at the end of a predetermined prediction time interval for a plurality of different possible boration/dilution actions based on the plurality of measurable reactor process variables and the plurality of non-measurable reactor process variables, the axial offset being a normalized difference between power of an upper half of the reactor core and a lower half of the reactor core, wherein the calculation of the future axial offset for each of the plurality of different possible boration/dilution actions is performed in parallel;
determining a boration/dilution action to be performed based on the calculated future axial offsets, AO, for the plurality of different possible boration/dilution actions and corresponding reference axial offsets, AOref; and
commanding the determined boration/dilution action in the primary cooling circuit.

21: The method according to claim 20, further comprising:
receiving a planned electric power change for a predetermined time, wherein the calculation of the future axial offsets, AO, for a plurality of different possible boration/dilution actions at the end of the predetermined prediction time interval is further based on the planned electric power change during predetermined prediction time interval.

22: The method according to claim 20, further comprising:
determining a current axial offset and, if the difference between the current axial offset and a current reference axial offset exceeds a predefined threshold; and
performing the step of calculating future axial offsets, AO, at the end of the predetermined prediction time interval for a plurality of different possible boration/dilution actions.

23: The method according to claim 20, wherein the measurable reactor process variables include:
a coolant inlet temperature;
a coolant outlet temperature;
an average coolant temperature;
a live steam pressure;
current axial offset;
a thermal power of the reactor core;
power control rod positions;
in-core neutron fluxes;
ex-core neutron fluxes, and/or
boron concentration.

24: The method according to claim 20, wherein the non-measurable reactor process variables include:
nuclide concentrations; reaction rates;
heating powers; fuel temperatures; and/or
coolant temperatures.

25: The method according to claim 20, wherein the non-measurable reactor variables are obtained by a reactor co-simulator.

26: The method according to claim 20, wherein the boration/dilution action to be performed is determined based on an interpolation between at least two points created by pairs of boration/dilution value and the calculated future axial offset.

27: The method according to claim 26, wherein a boration/dilution value for a boration/dilution action to be performed is selected from the interpolation such that the difference between the axial offset and the corresponding reference axial offset is zero.

28: The method according to claim 26, wherein a boration/dilution value for a boration/dilution action to be performed is selected from the interpolation such that the difference between the axial offset and the corresponding reference axial offset is zero when the corresponding reference axial offsets are equal.

29: The method according to claim 20, wherein the boration/dilution action to be performed is determined based on an interpolation between at least two points created by pairs of boration/dilution value and the difference between the calculated future axial offset and the corresponding reference axial offset.

30: The method according to claim 29, wherein a boration/dilution value for a boration/dilution action to be performed is selected where an interpolation curve of the interpolation presents a zero-crossing in a dimension representing the difference between the axial offsets and the corresponding reference axial offset.

31: The method according to claim 26, wherein the boration/dilution action to be performed is determined based on an interpolation between two neighboring points giving a smallest negative difference between the future axial offset and the corresponding reference axial offset and a smallest positive difference between a future axial offset and the corresponding reference axial offset.

32: The method according to claim 29, wherein the boration/dilution action to be performed is determined based on an interpolation between two neighboring points giving a smallest negative difference between the future axial offset and the corresponding reference axial offset and a smallest positive difference between a future axial offset and the corresponding reference axial offset.

33: The method according to claim 20, wherein the boration/dilution action to be performed is determined by selecting a boration/dilution action from the plurality of different possible boration/dilution actions, which leads to a smallest absolute difference between the respective future axial offset and the corresponding reference axial offset.

34: The method according to claim 20, wherein each calculation of a future axial offset at the end of predetermined time span for a plurality of different possible boration/dilution actions is based on the same reactor process variables except the boration/dilution action.

35: The method according to claim 20, wherein the predetermined prediction time interval is between 5 and 15 minutes.

36: The method according to claim 20, wherein the calculation of the future axial offsets at the end of a predetermined prediction time interval for a plurality of different possible boration/dilution actions is based on numerical solving of integral equations.

37: The method according to claim 20, wherein the calculation of the future axial offsets at the end of a predetermined prediction time interval for a plurality of different possible boration/dilution actions is based on numerical solving of integral equations based on reactivity balance equations.

38: The method according to claim 20, wherein the corresponding reference axial offset is respectively a reference axial offset at the end of the prediction time interval calculated for each possible boration/dilution action based on the reactor power and/or positions of power control rods at the end of the prediction time interval.

39: The method according to claim 20,
wherein the corresponding reference axial offsets are equal for each possible boration/dilution action,
wherein the corresponding reference axial offset is based on a measurement.

40: A computer program or FPGA configware product comprising:
commands for executing the method according to claim 20 when loaded and executed on a processor or on a FPGA.

41: A computer-readable data carrier having stored thereon the computer program or FPGA configware product of claim 40.

42: A data carrier signal carrying the computer program or FPGA configware product according to claim 40.

43: A control system for controlling a pressurized water nuclear reactor, the pressurized water nuclear reactor comprising a reactor core and a primary cooling circuit comprising a primary cooling medium, the system comprising:
an acquisition module adapted to acquire a plurality of measurable reactor process variables;
a reactor co-simulator adapted to obtain a plurality of non-measurable reactor process variables;
a multi-channel predictor adapted to receive the non-measurable reactor process variables and the measurable process variables, wherein the multi-channel predictor is further adapted to calculate future axial offsets at the end of a predetermined prediction time interval for a plurality of different possible boration/dilution actions based on the plurality of measurable reactor process variables and the plurality of non-measurable reactor process variables, the axial offset being a normalized difference between power of an upper half of the reactor core and a lower half of the reactor core, wherein the calculation of the future axial offset for each of the plurality of different possible boration/dilution actions is performed in parallel; and
an assessment device adapted to determine a boration/dilution action to be performed based the calculated future axial offsets for the plurality of different possible boration/dilution actions and corresponding reference axial offsets, AOref;
wherein the control system is further adapted to command the determined boration/dilution action in the primary cooling circuit.
